(19) United States
(12) Patent Application Publication
(10) Pub. No.: US 2023/0366200 A1
(43) Pub. Date: Nov. 16, 2023

(54) 3D-PRINTED TEXTURED WALL PANEL WITH SUPPORTING STRUCTURE

(71) Applicants: Mark Andrew Maxfield, Murray, UT (US); McKay Kenneth Christensen, Oak City, UT (US)

(72) Inventors: Mark Andrew Maxfield, Murray, UT (US); McKay Kenneth Christensen, Oak City, UT (US)

(73) Assignee: CreteTech LLC, Spanish Fork, UT (US)

(21) Appl. No.: 17/742,096

(22) Filed: May 11, 2022

(51) Int. Cl. E04B 2/00; E04C 2/04; E04C 2/30; E04C 2/52; B33Y 80/00; B33Y 10/00; B28B 1/00

(52) U.S. Cl. CPC E04C 2/46; E04C 2/044; E04C 2/30; E04C 2/521; E04C 2/526; B33Y 80/00; B33Y 10/00; B28B 1/001; E04C 2002/007

(57) ABSTRACT

An article of manufacture is disclosed comprising a 3D-printed wall panel having an interior side and an exterior side. The exterior side comprises a textured surface formed by 3D printing the wall panel onto a textured form. In certain embodiments, the textured surface mimics at least one of natural stone, brick, and wood siding, and the medium printed onto the textured form is concrete. The interior side has 3D printed structural elements printed thereon designed to mimic conventional wood-stud framing in at least one of dimensions and spacing. A method for fabricating the 3D printed wall panel as described above is also disclosed.

### BACKGROUND

### Field of the Invention

This invention relates to 3D-printed wall panels for buildings and methods for making the same.

### Background of the Invention

3D printing, or additive manufacturing, is overarching terminology for various manufacturing technologies that can generate parts or components by growing them out of a base material. This type of manufacturing differs from subtractive manufacturing, such as CNC machining, where a bulk material is reduced to its final shape through cutting or forming. 3D printing is a powerful tool for producing custom parts and components, often with complex geometries, and serves industries such as aerospace, defense, automotive, medical, dental, and the like.

Home construction is another application for 3D printing that is currently being explored to decrease construction costs and speed up the construction of new homes. In most applications for home construction that are currently being tested and explored, a large, portable 3D printer comprising a frame and printing head is typically assembled at the site where a home is to be built. The 3D printer is then operated under the control of software to vertically build up walls of a home, layer by layer, from a foundation. Concrete is the typical 3D printing medium used.

Unfortunately, 3D printing a home in the manner described above typically create walls with uneven and irregular external surfaces. These external surfaces often require additional finishing to provide a desired texture. This incurs additional expense which may reduce the technique's potential cost advantages. Furthermore, most 3D printing techniques currently being tested for home construction create unconventional wall structures that are unfamiliar to those that work in the traditional home-building industry. For example, the great majority of electricians, plumbers, finish carpenters, drywallers, painters, window installers, etc., may have difficulty applying their trades to these new types of 3D-printed building structures.

### SUMMARY

The invention has been developed in response to the present state of the art and, in particular, in response to the problems and needs in the art that have not yet been fully solved by currently available articles of manufacture and methods for making the same. Accordingly, new articles of manufacture and methods for making the same are disclosed. The features and advantages of various embodiments of the invention will become more fully apparent from the following description and appended claims, or may be learned by practice of the invention as set forth hereinafter.

Consistent with the foregoing, an article of manufacture is disclosed. The article of manufacture comprises a 3D-printed wall panel having an interior side and an exterior side. The exterior side comprises a textured surface formed by 3D printing the wall panel onto a textured form. In certain embodiments, the textured surface mimics at least one of natural stone, brick, and wood siding, and the medium printed onto the textured form is concrete. The interior side has 3D printed structural elements printed thereon designed to mimic conventional wood-stud framing in at least one of dimensions and spacing. In certain embodiments, the structural elements are embedded with a material (e.g., polymer) on an interior face thereof that differs from a primary material (e.g., concrete) of the 3D-printed wall panel. This embedded material enables attachment of drywall or other interior wall materials to the interior side of the 3D-printed wall panel. Similarly, in certain embodiments, the structural elements may be printed with cutouts that facilitate routing of at least one of plumbing and electrical wiring through the structural elements. In certain embodiments, the 3D-printed wall panel is also printed with openings for doors or windows and the structural elements are positioned and 3D printed on the wall panel to accommodate these openings.

A method for fabricating a 3D printed wall panel as described above is also disclosed.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing various embodiments of the invention;

FIG. 2 is a process flow diagram showing one embodiment of a method for designing a 3D-printed wall panel in accordance with the invention, wherein the method may be implemented on a computing system such as that illustrated in FIG. 1;

FIG. 3 is a process flow diagram showing one embodiment of a method for fabricating a 3D-printed wall panel as designed by the method of FIG. 2;

FIG. 4 is a perspective view showing one example of a 3D-printed wall panel in accordance with the invention;

FIG. 5 is a side, cross-sectional view of one example of a 3D-printed wall panel in accordance with the invention;

FIG. 6 is a rear view of one example of a 3D-printed wall panel in accordance with the invention;

FIG. 7 is a rear view of one example of a 3D-printed wall panel having a window formed therein; and

FIG. 8 is a rear view of one example of a 3D-printed wall panel having a doorway formed therein.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as an article of manufacture, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

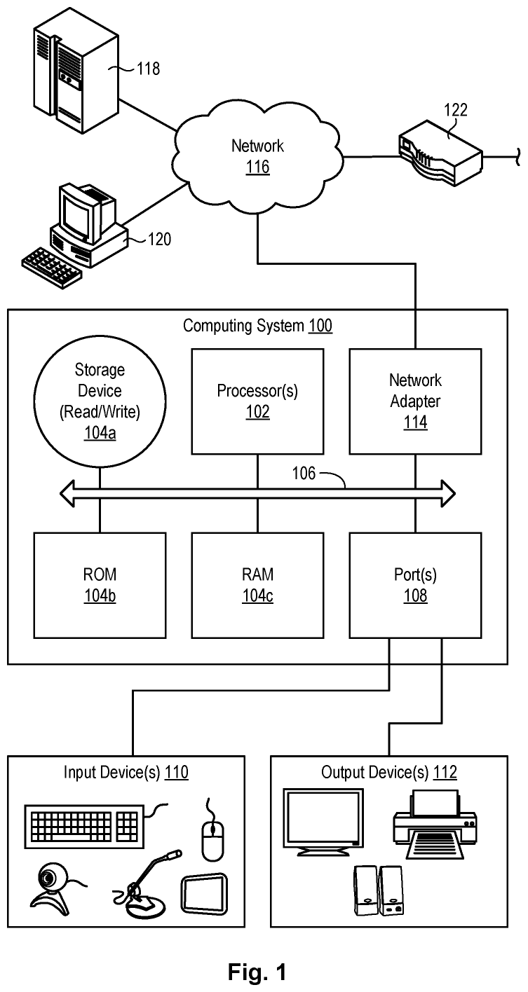

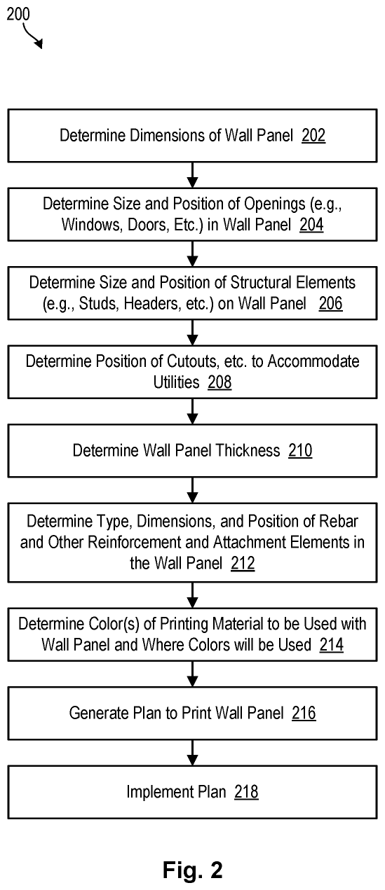

Referring to FIG. 1, one example of a computing system 100 is illustrated. The computing system 100 is presented to show one example of an environment where a method, such as the method 200 illustrated in FIG. 2, may be implemented. The computing system 100 may be embodied as a desktop computer, a workstation, a laptop computer, a server, a storage controller, a mobile device such as a smart phone or tablet, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a local area network (LAN), wide area network (WAN), storage area network (SAN), or the Internet. Such a network 116 may enable the computing system 100 to connect to or communicate with one or more servers 118, workstations 120, personal computers 120, mobile computing devices, or other devices. The network 116 may also enable the computing system 100 to connect to or communicate with another network by way of a router 122 or other device 122. Such a router 122 may allow the computing system 100 to communicate with servers, workstations, personal computers, or other devices located on different networks.

As previously mentioned, home construction is one potential application for 3D printing that is currently being explored to decrease construction costs and speed up the construction of new homes. In most applications for home construction that are currently being tested and explored, a large, portable 3D printer comprising a frame and printing head is typically assembled at the site where a home is to be built. The 3D printer is then operated under the control of software to vertically build up walls of a home, layer by layer, from a foundation. Concrete is the typical 3D printing medium used.

Unfortunately, 3D printing a home in the manner described above typically creates walls with uneven and irregular external surfaces. These external surfaces often require additional finishing to provide a desired texture. This incurs additional expense which may reduce the technique's potential cost advantages. Furthermore, most 3D printing techniques currently being tested for home construction create unconventional wall structures that are unfamiliar to those that work in the traditional home-building industry. For example, the great majority of electricians, plumbers, finish carpenters, drywallers, painters, window installers, etc., may have difficulty applying their trades to these new types of 3D-printed building structures.

In certain embodiments, instead of vertically building up walls of a home, layer by layer, from a foundation, methods in accordance with the invention may 3D print wall panels horizontally (e.g., on a flat surface such as on level ground) using a concrete mix with desired 3D printing characteristics. These 3D-printed wall panels may then be allowed to cure. The 3D-printed wall panels may then be transported to a construction site and stood upright in order to form the walls of a home. In certain embodiments, constructing buildings in this manner may require joints between the 3D-printed wall panels. These joints may act as expansion joints to prevent or reduce cracking of the 3D-printed wall panels as the walls expand and contract in response to thermal fluctuations. Thus, in certain embodiments, constructing 3D-printed wall panels in this manner may be superior in that it may inherently provide expansions joints in the walls to prevent or reduce cracking.

Referring to FIG. 2, a process flow diagram showing one embodiment of a method 200 for designing a 3D-printed wall panel in accordance with the invention is illustrated. In certain embodiments, such a method 200 may be implemented on a computing system 100, such as that illustrated in FIG. 1, prior to 3D printing the wall panel.

As shown, in certain embodiments, the method 200 may initially determine 202 dimensions of a wall panel for use in a home or other building. In certain embodiments, this may be accomplished by taking home or building plans and breaking up walls into wall panels of a manageable size. In certain embodiments, natural break points may be selected based on features (e.g., wall dimensions, door locations, window locations, corners, etc.) of the walls of the home. In certain cases, break points may be selected at locations that are more easily obscured or hidden.

Once dimensions of a wall panel are determined 202, the method 200 may determine 204 the size and position of openings (e.g., doors, windows, cutouts for lighting, plumbing, vents, etc.) on the wall panel. The method 200 may then determine 206 the size and position of structural elements in the wall panel. In certain embodiments, structural elements may be designed on the wall panel to mimic conventional wood-stud framing in terms of dimensions and/or spacing. This provides several advantages. For example, designing the structural elements in this manner may provide some level of familiarity to tradesman accustomed to working with wood-stud framing, such as electricians, plumbers, finish carpenters, drywallers, painters, window installers, and the like. This may help the tradesman more easily apply their skillsets to 3D-printed wall panels and thereby speed up the construction of the home. Furthermore, designing the structural elements to mimic conventional wood-stud framing may further enable conventional wall materials (e.g. insulation, drywall, etc.) to line up and be used with the wall panel with as little cutting or modification as possible. In other words, designing the 3D-printed wall panels in this manner may enable the 3D-printed wall panels to more easily interface with conventional building materials in their traditional shapes and sizes.

The method 200 may then determine 208 the position of cutouts in the 3D-printed wall panels to accommodate utilities. For example, the method 200 may determine where electrical wires, plumbing, communication wires, etc. should be routed through the structural elements and plan for 3D-printed cutouts or holes in the structural elements (e.g., studs, top plates, bottom plates, headers, fire blocks, etc.) to accommodate these utilities. In certain embodiments, the method 200 may also plan to 3D print structures such as electrical junction boxes or conduits in the 3D-printed wall panel.

The method 200 may also determine 210 the wall panel thickness. This may include the thickness of the exterior face of the 3D-printed wall panel as well as the thickness of the structural elements. In certain embodiments, the thickness of the 3D-printed wall panel may depend on the dimension of the 3D-printed wall panel. For example, taller wall panels or those that will bear more weight may require a thicker exterior face and, or thicker structural elements (e.g., 2×6 stud dimensions as opposed to 2×4 stud dimensions), or possibly closer spacing of the structural elements.

The method 200 may also determine 212 the type, dimensions, and position of rebar and other reinforcement or attachment elements in the wall panel. For example, when designing the wall panel, various portions of the wall panel may need to be reinforced with rebar or other reinforcing elements. In certain embodiments, the method 200 may determine where to place reinforcing elements to provide needed strength and load-bearing capability. In addition, the method 200 may determine where to place or embed attachment elements in the wall panel. Such attachment elements may include, for example, polymer or wood strips that are embedded on interior faces of the structural elements in order to attach materials such as drywall to the 3D-printed wall panel.

In certain embodiments, the method 200 may also determine 214 what colors of concrete or other printing media are to be used with the wall panel. For example, in certain embodiments, an exterior surface of the wall panel may be printed with a colored concrete or even multiple colors of concrete for aesthetic reasons. An interior surface and/or structural elements of the wall panel may, by contrast, be printed with uncolored concrete to reduce costs and/or because these elements will be hidden from view.

Once the determinations 202, 204, 206, 208, 210, 212, 214 are made, the method 200 may generate 216 a plan to 3D print the wall panel. This may include determining what passes or strokes are needed by the 3D printing head to print the wall panel, when colors need to be changed, when the printing head must stop to allow rebar or other reinforcing or attachment elements to be placed in the wall panel, and the like. The method 200 may then implement 218 the plan to print the wall panel.

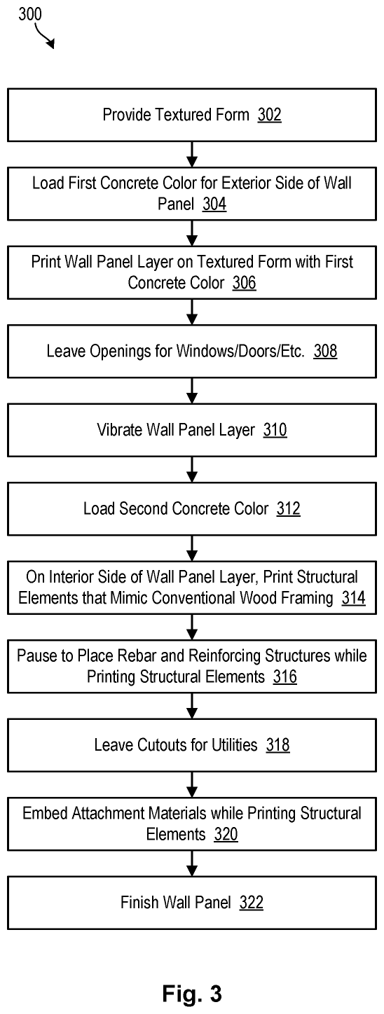

Referring to FIG. 3, a process flow diagram is illustrated showing one embodiment of a method 300 for printing a 3D-printed wall panel, such as a 3D-printed wall panel designed using the method 200 of FIG. 2. As shown, the method 300 initially provides 302 a textured form on which to print the wall panel. This textured form may be as simple as a horizontal surface with a rock, brick, wood siding, or other texture or pattern formed thereon. In other embodiments, the textured form is simply a flat horizontal surface onto which the wall panel is printed. This horizontal surface may be fabricated from a material that does not bond with concrete and/or from which the 3D-printed wall panel may be easily separated after it has cured. Printing the wall panel onto a textured form may provide a desired exterior texture and color to the wall panel to eliminate or reduce the need for additional exterior finishing. This may significantly reduce costs when fabricating a home or other building.

The method 300 then includes loading 304 a first concrete color into the 3D printer that corresponds to a desired exterior color for the wall panel. The method 300 then prints 306 a wall panel layer onto the textured form with the thickness, dimensions, etc. determined in the design process 200. This printing process may include leaving 308 openings for doors, windows, holes for wiring/plumbing, etc. in the wall panel with the dimensions and locations determined in the design process 200. In certain embodiments, the wall panel as well as the doors/windows/etc. are 3D printed with a concrete mixture of sufficient viscosity to allow the wall panel and structural elements to be printed on a horizontal surface without needing any forms around the edges of the wall panel, doors/windows, or structural elements, to keep the concrete mixture from flowing.

In certain embodiments, when the wall panel is printed onto the textured form, the wall panel may be vibrated 310 to ensure that the concrete mix fully settles into the form and thereby imparts the desired texture to the exterior surface with as few bubbles or imperfections as possible. Once an initial layer of colored concrete of a desired thickness is 3D printed onto the textured form, the method 300 may load a second concrete color into the 3D printer, such as a neutral or uncolored concrete mixture, to print a remaining portion of the wall panel.

The method 300 may then continue printing 314 to an interior surface of the wall panel to achieve a desired thickness of the wall panel. The method 300 may similarly print 314 the structural elements on the inside of the wall panel. As previously mentioned, the size, dimensions, spacing, etc. may, in certain embodiments, be printed to mimic conventional wood framing. For example, the structural elements may be printed with dimension similar to 2×3, 2×4, 2×6, 2×8, 2×10, 2×12, etc. studs (e.g., within 10 or 20 percent of the dimensions of conventional or rough sawn wood studs), and with spacing (e.g., 12, 16 or 24 inches on center), that are used in conventional wood framing. Nevertheless, the structural elements 404 are not limited to these dimensions and/or spacing.

Similarly, the structural elements may be printed on the back of the wall panel as studs, headers, top plates, bottom plates, top and bottom cripple studs, corner posts, sills, king studs, trimmer studs, and the like, as used in conventional wood framing. Each of these structural elements may be reinforced with rebar or other reinforcing elements where needed to provide desired strength and load-bearing characteristics. 3D printing the structural elements in this way and with these spacing/dimensions may provide a level of familiarity to tradesman experienced in conventional wood framing or that have trades or skillsets that interface with conventional wood framing. Furthermore, 3D printing the structural elements in this manner enables interfacing with traditional building materials (e.g., drywall, insulation, moisture barrier, paneling, plumbing components, electrical components, etc.) with as little modification as possible.

During the 3D printing process, the method 300 may pause 316 at selected times or intervals to enable a user or machine to place rebar or other reinforcing elements into the structural elements. This may be performed to impart strength to the structural elements that is on par with or greater than conventional wood framing. Furthermore, during the 3D printing process, the method 300 may, in certain embodiments, leave 318 cutouts in the structural elements and wall panel for utilities such as electrical and plumbing. In certain embodiments, this is accomplished by placing small forms in the structural elements or wall panel during the 3D printing process to leave the desired cutouts therein.

During the 3D printing process, the method 300 may also pause at selected times or intervals to enable a user or machine to embed 320 attachment materials into the structural elements or other parts of the wall panel. For example, in selected embodiments, strips of polymer or wood may be embedded into an interior face of the structural elements. These attachment materials may enable sheets of drywall or other interior materials to be screwed into or otherwise attached to the 3D-printed wall panels as is currently performed with conventional wood framing. This may provide yet another characteristic to enable the 3D-printed wall panels to perform like conventional wood-framed walls.

Once the 3D printing process is complete, the method 300 may finish 322 the wall panel. In certain embodiments, this may entail using a trowel, broom, brush, or other concrete tool to smooth or texture edges or other parts (e.g., around doors, windows, etc.) of the 3D-printed wall panel. In certain embodiments, a sealer, stain, or other treatment may be applied to the concrete wall panel to provide a moisture barrier or impart a desired finish, color, or sheen to the wall panel. This may be performed before or after the wall panel cures.

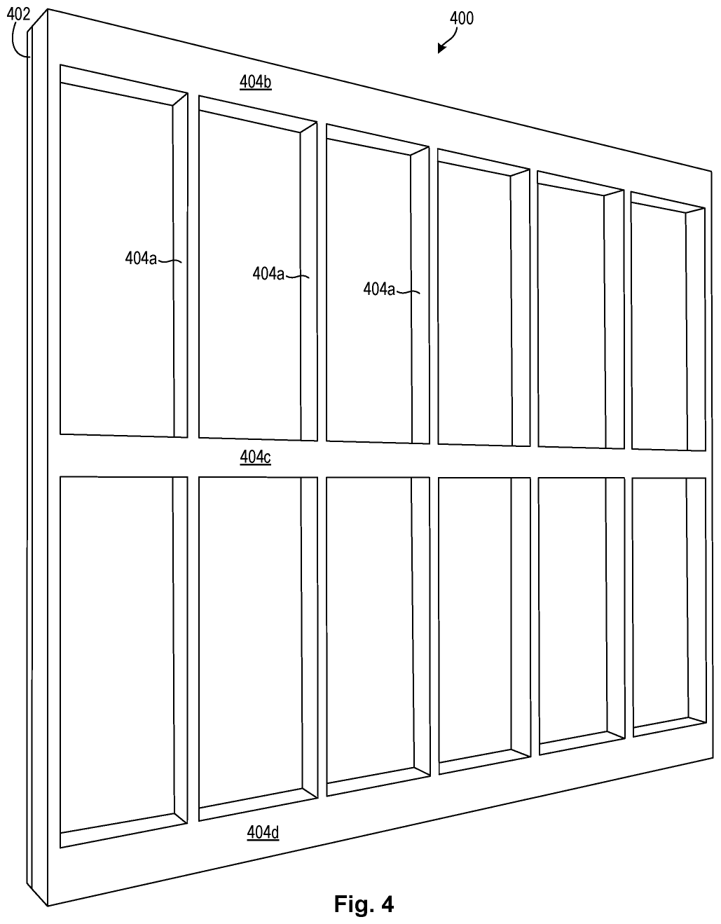

FIG. 4 is a perspective view showing one example of a very simple 3D-printed wall panel 400 in accordance with the invention. In this example, the 3D-printed wall panel 400 includes a textured front face 402 that was formed by printing it onto a textured form. Behind the front face 402, the 3D-printed wall panel 400 includes structural elements 404 that mimic conventional wood-stud framing in one or more of dimensions and spacing. For example, the structural elements 404a may have substantially the same dimension as 2×4 or 2×6 wood studs used in conventional home construction. Similarly, the structural elements 404a may be spaced at 16 or 24 inch centers as used in conventional home construction. This may enable conventional wall materials (e.g. insulation, drywall, paneling, etc.) to line up and be used with the structural elements 404 with as little cutting or modification as possible. As further shown in FIG. 4, the structural elements 404 printed on the back of the 3D-printed wall panel 400 may include headers 404b or top plates 404b, fire blocks 404c, and bottom plates 404d, as used in conventional home construction, in addition to the concrete studs 404a.

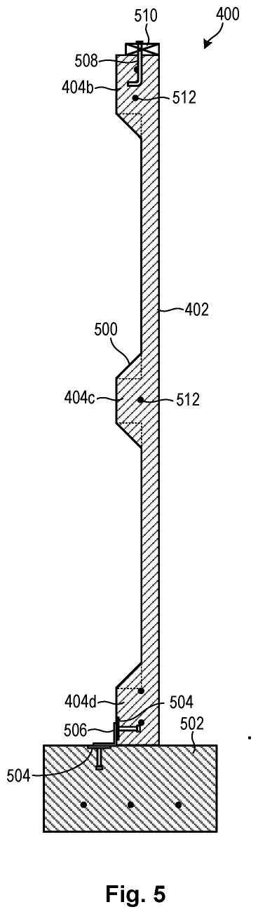

FIG. 5 is a side, cross-sectional view of one example of a 3D-printed wall panel 400 in accordance with the invention. As shown, the 3D-printed wall panel 400 includes the textured front face 402 or layer 402 and various structural elements 404b-d, namely the headers 404b or top plates 404b, fire blocks 404c, and bottom plates 404d behind the layer 402. The studs 404a are not shown in this embodiment since the cross-section is taken between the studs 404a. In this particular example, the structural elements 404b-d form a forty-five degree angle 500 with respect to the layer 402 although the structural elements 404b-d may alternatively interface with the layer 402 at a right angle as shown by the dotted lines.

As shown in FIG. 5, the 3D-printed wall panel 400 may be coupled to a footing 502 when constructing a home or other building. In certain embodiments, each of the 3D-printed wall panel 400 and footing 502 may have a mounting plate 504 embedded therein to provide a mounting point. A bracket 506 may be used between the mounting plates 504 to couple the 3D-printed wall panel 400 to the footing 502. At a top of the 3D-printed wall panel 400, an anchor bolt 508 may be embedded in the 3D-printed wall panel 400 to connect the 3-D-printed wall panel 400 to other structures 510, such as the illustrated plate 510. This may allow trusses, rafters, or other structures to be attached to a top of the 3D-printed wall panel 400. The black dots shown in FIG. 5 (not all of which are labelled) represent rebar or other reinforcing structures that are embedded within the 3D-printed wall panel 400 and footing 502 respectively to impart additional strength and load-bearing characteristics thereto.

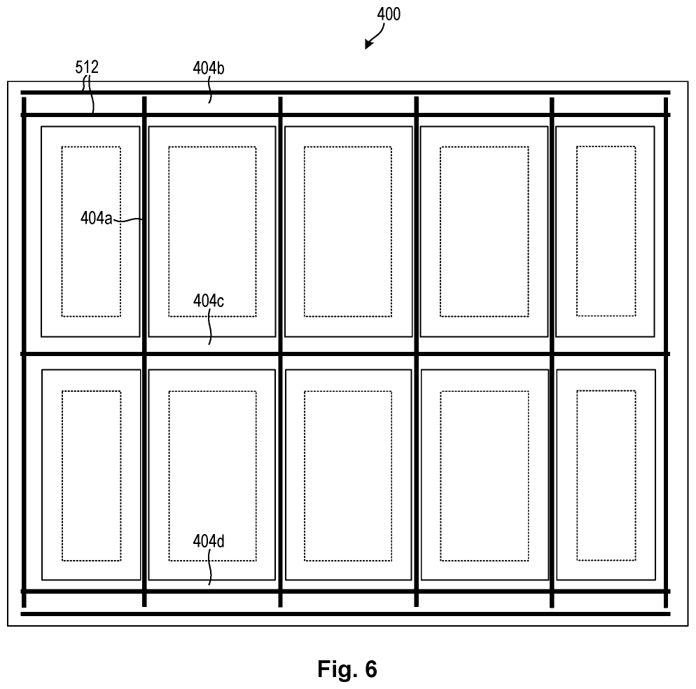

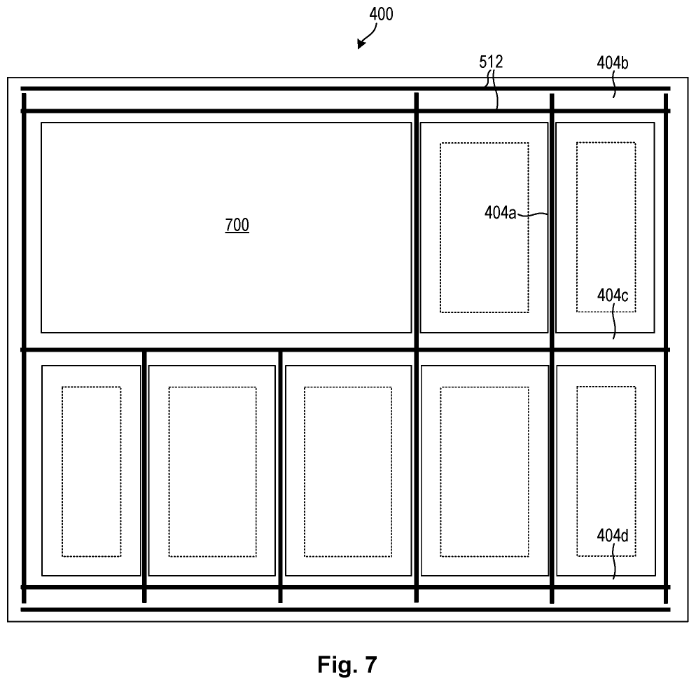

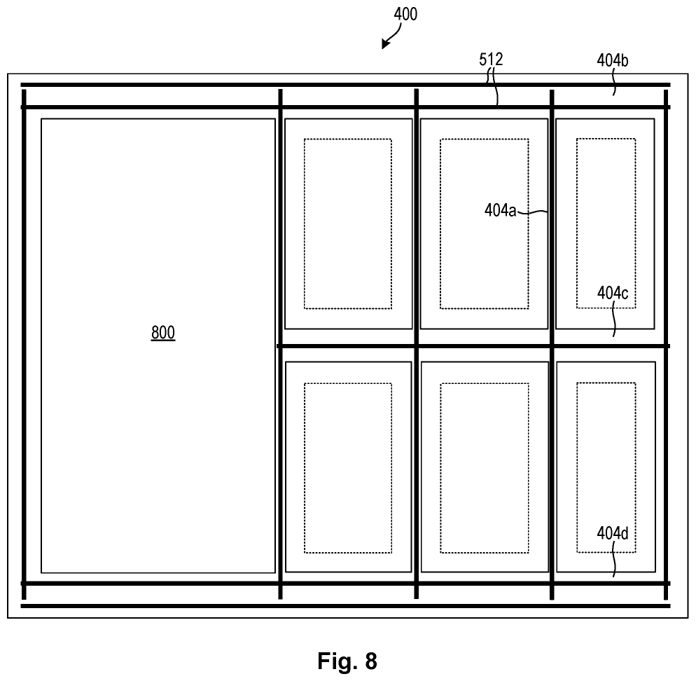

FIGS. 6 through 8 show various different examples of a 3D-printed wall panels 400 in accordance with the invention. FIG. 6 shows a 3D-printed wall panel 400 with no windows, doors, or other openings. FIG. 7 shows a 3D-printed wall panel 400 with a window opening 700 formed therein. FIG. 8 shows a 3D-printed wall panel 400 with a doorway 800 formed therein. Each of the embodiments shows the structural elements 404 that make up the 3D-printed wall panel 400, as well as rebar 512 or other reinforcing structures 512 (as shown by the heavy black lines) that are embedded within the 3D-printed wall panels 400 to provide additional strength and load carrying capacity thereto.

It should be recognized that the processes and associated structures disclosed herein as they relate to “3D printed wall panels” could be applied to other types of 3D printed panels such as 3D printed ceiling panels, 3D printed floor panels, 3D printed roof panels, and the like. Thus, the processes and structures disclosed herein are not limited to 3D printed wall panels but may include any type of panel used in the construction of new homes and buildings.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. An article of manufacture comprising:
a 3D-printed wall panel having an interior side and an exterior side;
the exterior side comprising a textured surface formed by 3D printing the wall panel onto a textured form; and
the interior side having 3D printed structural elements printed thereon designed to mimic conventional wood-stud framing in at least one of dimensions and spacing.

2. The article of manufacture of claim 1, wherein the 3D-printed wall panel is primarily made of concrete.

3. The article of manufacture of claim 1, wherein the exterior side is fabricated from a colored concrete that is colored differently than the interior side.

4. The article of manufacture of claim 1, wherein the textured surface mimics at least one of natural stone, brick, and wood siding.

5. The article of manufacture of claim 4, wherein the textured surface comprises multiple colors to mimic at least one of natural stone, brick, and wood siding.

6. The article of manufacture of claim 5, wherein the structural elements comprise an embedded material that differs from a primary material of the 3D-printed wall panel, the embedded material designed to enable attachment of drywall or other interior wall materials to the interior side of the 3D-printed wall panel.

7. The article of manufacture of claim 1, wherein the structural elements comprise cutouts that facilitate routing of at least one of plumbing and electrical wiring through the structural elements.

8. The article of manufacture of claim 7, wherein the cutouts are 3D printed into the structural elements.

9. The article of manufacture of claim 1, wherein the 3D-printed wall panel is printed with an opening for at least one of a door and window in the 3D-printed wall panel.

10. The article of manufacture of claim 9, wherein the structural elements are printed on the 3D-printed wall panel to facilitate the opening.

11. A method comprising:
3D printing, onto a textured form, a wall panel comprising an interior side and an exterior side, the textured form configured to impart a textured surface onto the exterior side; and
3D printing, on the interior side, structural elements designed to mimic conventional wood-stud framing in at least one of dimensions and spacing.

12. The method of claim 11, wherein 3D printing comprises 3D printing a concrete mixture.

13. The method of claim 11, wherein 3D printing comprises 3D printing the exterior side with a colored concrete that is different than that used to 3D print the interior side.

14. The method of claim 11, wherein the textured surface mimics a texture of at least one of natural stone, brick, and wood siding.

15. The method of claim 14, wherein the textured surface comprises multiple colors to mimic at least one of natural stone, brick, and wood siding.

16. The method of claim 15, further comprising embedding, within the structural elements, a material that differs from a primary material of the 3D-printed wall panel, the embedded material designed to enable attachment of drywall or other interior wall materials to the interior side of the 3D-printed wall panel.

17. The method of claim 11, further comprising 3D printing, into the structural elements, cutouts that facilitate routing of at least one of plumbing and electrical wiring through the structural elements.

18. The method of claim 11, further comprising vibrating the wall panel that is 3D printed onto the textured form.

19. The method of claim 11, further comprising 3D printing into the wall panel an opening for at least one of a door and window.

20. The method of claim 19, further comprising 3D printing the structural elements onto the wall panel to facilitate the opening.
